(19) United States
(12) Patent Application Publication
(10) Pub. No.: US 2022/0129071 A1
(43) Pub. Date: Apr. 28, 2022

(54) Systems and Methods for Nonlinear Latent Spatiotemporal Representation Alignment Decoding for Brain-Computer Interfaces

(71) Applicants: Emory University, Atlanta, GA (US); Georgia Tech Research Corporation, Atlanta, GA (US); Northwestern University, Evanston, IL (US)

(72) Inventors: Chethan Pandarinath, Decatur, GA (US); Mohammadreza Keshtkaran, Atlanta, GA (US); Yahia Hassan Ali, Atlanta, GA (US); Lahiru Neth Wimalasena, Atlanta, GA (US); Andrew Robert Sedler, Atlanta, GA (US); Lee Eugene Miller, Chicago, IL (US); Josephine Jane Wallner, Chicago, IL (US); Xuan Ma, Chicago, IL (US); Ali Farshchian, Chicago, IL (US); Brianna Marie Karpowicz, Atlanta, GA (US)

(21) Appl. No.: 17/512,339

(22) Filed: Oct. 27, 2021

Related U.S. Application Data
(60) Provisional application No. 63/105,918, filed on Oct. 27, 2020.

(51) Int. Cl. G06F 3/01; G06N 3/08; G06N 3/06

(52) U.S. Cl. CPC G06F 3/015; G06N 3/061; G06N 3/08

(57) ABSTRACT

The disclosures relates to systems and methods for using a trained alignment neural network along with a trained latent representation model to achieve accurate alignment between complex neural signals arising from co-variation across neuron populations over time and their intended motor control that can be invariant for a much longer period without supervised recalibrations. In one implementation, the method may include receiving neural data for a period of time from one or more sensors. The method may further include transforming the neural data to generate aligned variables using a trained alignment network. The method may also include processing the aligned variables through a trained latent model to determine a latent spatiotemporal representation of one or more brain state variables for the period of time and decoding the latent spatiotemporal representation into a brain state for the period of time.

### CROSS-REFERENCE TO RELATED APPLICATIONS

This application claims the benefit of U.S. Provisional Application No. 63/105,918 filed Oct. 27, 2020. The entirety of this application is hereby incorporated by reference for all purposes.

### STATEMENT REGARDING FEDERALLY SPONSORED RESEARCH OR DEVELOPMENT

This invention was made with government support under NS053603 awarded by the National Institutes of Health and HR0011-19-9-0045 awarded by the Defense Advanced Research Projects Agency (DARPA). The government has certain rights in the invention.

### BACKGROUND

Brain-computer interfaces (BCI) translate neural activities to commands capable of controlling devices, such as robotic hardware, neural prostheses, prosthetics, input devices (e.g., for typing and/or speech), etc. Current BCI technology generally uses a trained decoder to decode a user's intentions directly from brain signals, for example, collected by implanted electrodes, without involving any muscles or peripheral nerves, for example, to control these devices. However, due to neural interface instabilities, for example, slight displacements of the implanted electrodes (relative to the surrounding brain tissue), changes in recorded neuron identity can occur and lead to intraday and inter-day instabilities, confounding the decoding of intent.

To address these instabilities, the decoder has to be recalibrated at least once and even multiple times per day. Such constantly changing decoders can be challenging in practical conditions because it generally requires significant user, time and resource burdens, interrupts device use and typically requires third-party intervention.

### SUMMARY

Thus, there is a need for maintaining stable neural decoders that can improve stability and performance of neural-controlled devices, such as prosthetics, thus enabling clinical usage of brain-computer interfaces.

Techniques disclosed herein relate generally to using a trained alignment neural network along with a trained latent representation model to achieve accurate alignment between complex neural signals arising from co-variation across neuron populations over time. Successful alignment allows the brain-state decoding achieved by a neural-controlled device to be invariant for a much longer period. Thus, the disclosed techniques can result in consistent and accurate performance of neural-controlled devices without frequent, supervised recalibration.

The disclosed embodiments may include computer-implemented systems and methods for stabilizing a brain computer interface (BC) so that the a target device may controlled for long periods of time without supervised recalibration. The method may include receiving neural data for a period of time from one or more sensors. The method may also include transforming the neural data to generate aligned variables using a trained alignment network. The method may further include processing the aligned variables through a trained latent model to determine a latent spatiotemporal representation of one or more brain state variables for the period of time. The method may also include decoding the latent spatiotemporal representation into a brain state for the period of time.

In some embodiments, the system may include one or more processors; and one or more hardware storage devices having stored thereon computer-executable instructions. The instructions may be executable by the one or more processors to cause the computing system to perform at least receiving neural data for a period of time from one or more sensors. The one or more processors may be further configured to cause the computing system to perform at least transforming the neural data to generate aligned variables using a trained alignment network. The one or more processors may be also configured to cause the computing system to perform at least processing the aligned variables through a trained latent model to determine a latent spatiotemporal representation of one or more brain state variables for the period of time and decoding the latent spatiotemporal representation into a brain state for the period of time.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The disclosure can be better understood with the reference to the following drawings and description. The components in the figures are not necessarily to scale, the emphasis being placed upon illustrating the principles of the disclosure.

FIG. 1 illustrates an example of a system environment for determining a brain state using a trained latent model and alignment network according to embodiments.

FIG. 2 is a flow chart illustrating an example of a method of determining a brain state using trained latent model and alignment network according to embodiments.

FIG. 3 shows an example of architecture to train the latent model and alignment network according to embodiments.

FIG. 4 shows an example of architecture to train the latent model according to embodiments.

FIG. 5 is a flow chart illustrating an example of a method of training an alignment network according to embodiments.

FIG. 6 shows an example of results demonstrating the advantage of using the disclosed method to align latent representations across days prior to decoding a behavioral parameter.

FIG. 7 is a simplified block diagram of an example of a computing system for implementing certain embodiments disclosed herein.

### DESCRIPTION OF THE EMBODIMENTS

In the following description, numerous specific details are set forth such as examples of specific components, devices, methods, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

The disclosed embodiments relate to techniques that can uncover latent spatiotemporal representations (e.g., manifolds and dynamics) from neural activity and adjust to neural interface instabilities that can occur from use. The techniques use a trained latent model that uses recurrent networks along with a trained alignment neural network that can align new data from previously-unseen neural populations onto a previously-determined latent spatiotemporal representation. Because the trained model and the network are unsupervised, they do not require data collected explicitly for recalibration. Achieving automated alignment of changing neural data can enable stable and robust brain state decoding that is independent of neuronal turnover, without interrupting device use. Thus, the disclosed embodiments can improve accuracy while minimizing or eliminating reliance on supervised recalibration that might otherwise be needed daily or multiple times per day.

While examples of the disclosure may be specific to controlling a device, such as a prosthetic device, it will be understood that these examples are nonlimiting and that the methods and systems may be used to control stimulation delivered by a therapeutic neurostimulation device.

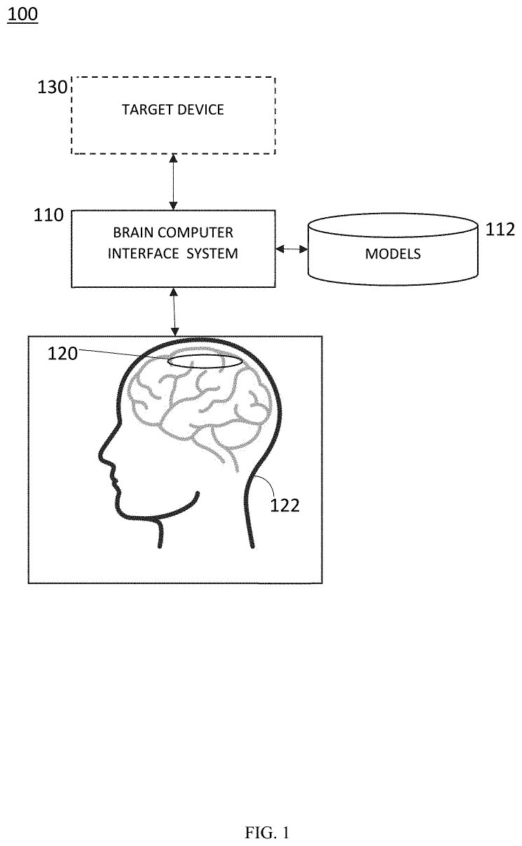

FIG. 1 depicts an example system environment 100 that can include a neural data analysis system 110 that is configured to decode neural data of a user 122 received from one or more sensors (e.g., microelectrode array) 120 using an unsupervised, trained alignment network and latent model stored in a database 112 to a command, corresponding to a brain state, for controlling a target device 130 according to embodiments. In some embodiments, the neural data may include at least one raw neural signal indicative of brain activity received from at least one sensor (e.g., electrode) for a period of time, for example, from a continuous feed. This raw neural signal can reflect the activity of individual neurons, groups of neurons, or field-potential measurements.

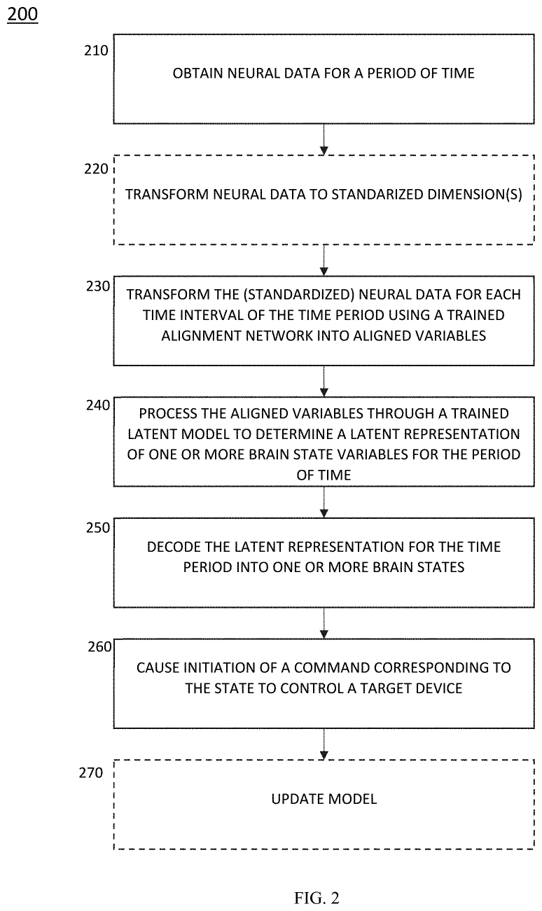

In some embodiments, the unsupervised trained alignment network may be a neural network. For example, the trained alignment network may be a feed-forward neural network (FFN), residual network, recurrent neural network (RNN), or neural network with attention mechanisms such as a transformer. Recurrent neural networks may take various forms including gated recurrent units, long short-term memory networks, vanilla RNNs, or variants. FIGS. 2, 3 and 5 show an example of training the alignment network according to embodiments.

In some embodiments, the trained latent model may have an encoder and a generator. For example, FIGS. 2-4 show an example of training the latent model according to embodiments. The encoder may process data at its input such that it outputs one or more compressed representations (422 and 432), and the generator may produce further representations (450) based on the compressed representations produced by the encoder. The representations produced by the generator may be used to reconstruct the observed neural activity.

In some embodiments, the trained latent model may uncover latent spatiotemporal representations that model the progression of brain states over time periods, that is, across multiple time points, rather than single time points. Modeling the progression of brain states across multiple time points can lead to more accurate inferences of brain states.

In some embodiments, the trained latent model may be able to infer time-varying inputs (432) to the neural population being monitored. Such inputs may reflect signals being conveyed to a brain region being monitored by another brain region that may or may not be simultaneously monitored. These inputs may also be an abstract quantity that reflects information that is not present in the neural activity of a particular brain region prior to a certain timestep.

In some embodiments, the trained latent model may model the spatiotemporal dynamics of the neuronal activity using the generator RNN (440). The generator RNN may approximate the spatiotemporal dynamics of a brain region as a nonlinear dynamical system, as implemented by its recurrent weights. The spatiotemporal dynamics of the brain region may be a property of the brain region that is invariant across time. Having an approximation of those spatiotemporal dynamics in the generator RNN may provide a critical constraint that helps achieve better alignment of changing neural data by providing some knowledge about previously-unseen neural activity, that is, that the neural activity must be able to be reconstructed by the spatiotemporal dynamics of the RNN.

In some embodiments, the neural data analysis system 110 may include any computing or data processing device consistent with the disclosed embodiments. In some embodiments, the system 110 may incorporate the functionalities associated with a personal computer, a laptop computer, a tablet computer, a notebook computer, a hand-held computer, a personal digital assistant, a portable navigation device, a mobile phone, an embedded device, a smartphone, and/or any additional or alternate computing device/system. The system 110 may transmit and receive data across a communication network. In some embodiments, the neural data analysis system 110 may be envisioned as a brain computer interface controlling the target device 130 according to the decoded neural data.

In some embodiments, the one or more sensors 120 may be operatively connected (invasively and/or non-invasively) to the user 122 and configured to generate one or more signals (“neural signals”) responsive to the user's brain activity. In some embodiments, the one or more sensors 120 may be any currently available or later developed invasive sensor(s), non-invasive(s) sensors, or any combination thereof. In some examples, the one or more sensors 120 may be operatively connected with a motor cortex of the user. For example, the sensor(s) may include an microelectrode array disposed in the brain (e.g., primary motor cortex, premotor cortex, parietal cortex, cingulate cortex, etc.) of the user configured to obtain neural data; a wearable microelectrode array (e.g., integrated into a headband, hat, eyeglasses, other head-worn article, among other, or any combination thereof) that can be disposed outside of the skull and configured to obtain neural data (e.g., from the primary motor cortex) noninvasively, such as a human machine/computer interface; among others; or any combination thereof. For example, the one or more sensors 120 can include a plurality of EEG electrodes (either “wet” or “dry” electrodes) configured to generate multi-channel EEG data responsive to the user's brain activity.

In some embodiments, the target device 130 may include but is not limited to a communication device (e.g., typed, displayed, audible, etc.), robotic arm or device, full limb prosthesis, partial limb prosthesis, neuroprosthesis or functional electrical stimulation (FES) device that actuates a paralyzed limb, an orthotic device, a deep brain stimulation device, a remote hands free device (e.g., a robot or an unmanned aerial vehicle), a motor vehicle, a cursor on a computer screen, among others, or a combination thereof. In some examples, such as a deep brain stimulation device, the sensor(s) 120 and the target device 130 (e.g., stimulating electrodes) may be provided in a single device.

In some embodiments, the neural data analysis system 110 may be configured to communicate with the one or more sensors 120, the target device 130, another programming or computing device via a wired or wireless connection using any of a variety of local wireless communication techniques, such as RF communication according to the 802.11 or Bluetooth specification sets, infrared (IR) communication according to the IRDA specification set, or other standard or proprietary telemetry protocols. The system 110 may also communicate with other programming or computing devices, such as the target device 130, or one or more sensors 120, via exchange of removable media, such as memory cards. In other embodiments, the one or more sensors 120 and/or the target device 130 may incorporate the functionalities discussed and associated with the system 110.

Although the systems/devices of the environment 100 are shown as being directly connected, the device 110 may be indirectly connected to one or more of the other systems/devices of the environment 100. In some embodiments, the device 110 may be only directly connected to one or more of the other systems/devices of the environment 100.

It is also to be understood that the environment 100 may omit any of the devices illustrated and/or may include additional systems and/or devices not shown. It is also to be understood that more than one device and/or system may be part of the environment 100 although one of each device and/or system is illustrated in the environment 100. It is further to be understood that each of the plurality of devices and/or systems may be different or may be the same. For example, one or more of the devices may be hosted at any of the other devices.

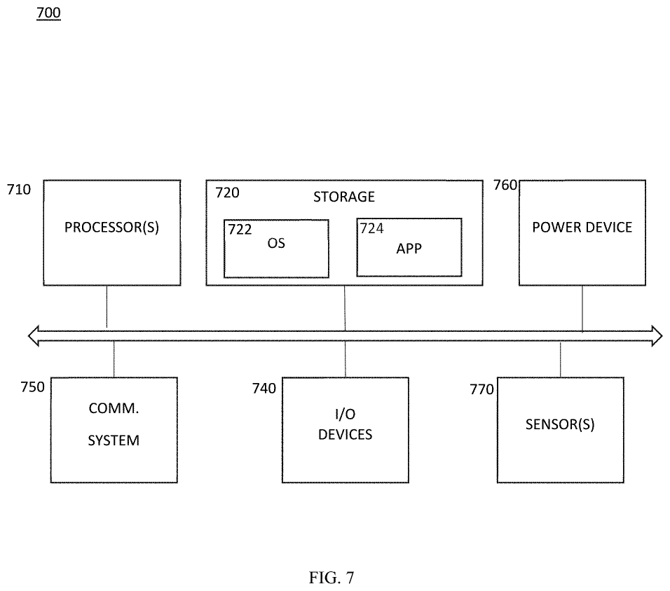

FIGS. 2-5 shows flow charts/architectures according to embodiments. Operations described in flow charts/architecture 200-500 may be performed by a computing system, such as the system 110 described above with respect to FIG. 1 or a computing system described below with respect to FIG. 7. Although the flow charts/architectures 200-500 may describe the operations as a sequential process, in various embodiments, some of the operations may be performed in parallel or concurrently. In addition, the order of the operations may be rearranged. An operation may have additional steps not shown in the figure. In some embodiments, some operations may be optional. Embodiments of the method/architecture may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium.

FIG. 2 shows flow chart 200 illustrating examples of a method of decoding neural data into control signals for controlling the target device using the trained alignment network and latent model according to embodiments. Operations in flow chart 200 may begin at block 210, the system 110 may receive neural data associated with a user for a period of time from the one or more sensors 120. For example, the neural data may be received from a microelectrode array disposed in the motor cortex of the user.

In some embodiments, the device 110, at block 220, may optionally transform the neural data to standardized dimension(s)(referred to as “standardized neural data”). For example, the neural data may be transformed to reduce dimensions, for example, using a linear dimensionality reduction technique, to a standardized spatial dimension. For example, this can address if one or more of the electrodes of the microelectrode array malfunctions.

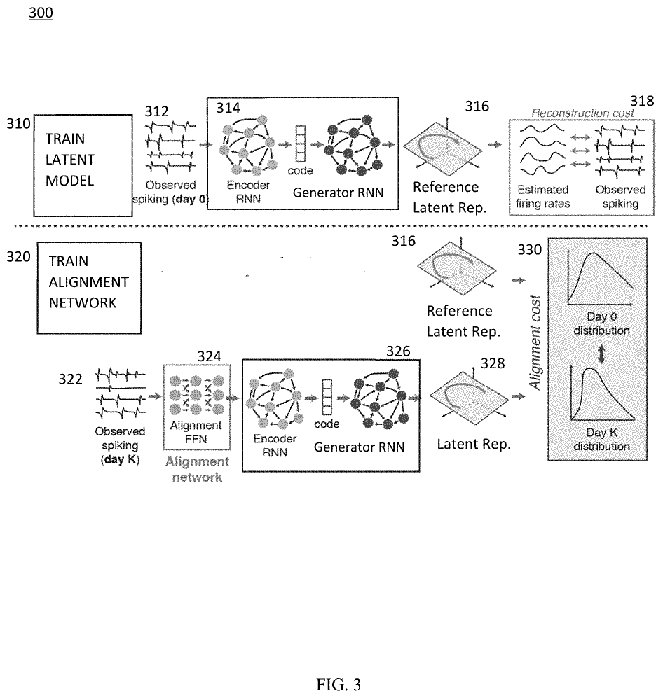

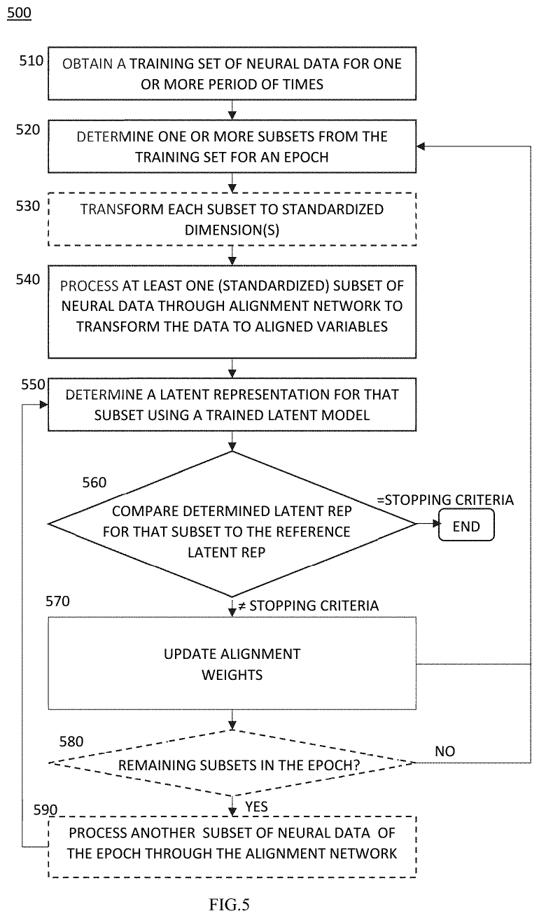

In some embodiments, the system 110, at block 230, may transform the (standardized) neural data into aligned variables using the trained aligned network according to embodiments (see, e.g., FIGS. 3 and 5). For example, the system 110 may apply the transformation using the weights of the trained alignment network and the alignment network architecture to the neural data to generate the aligned variables.

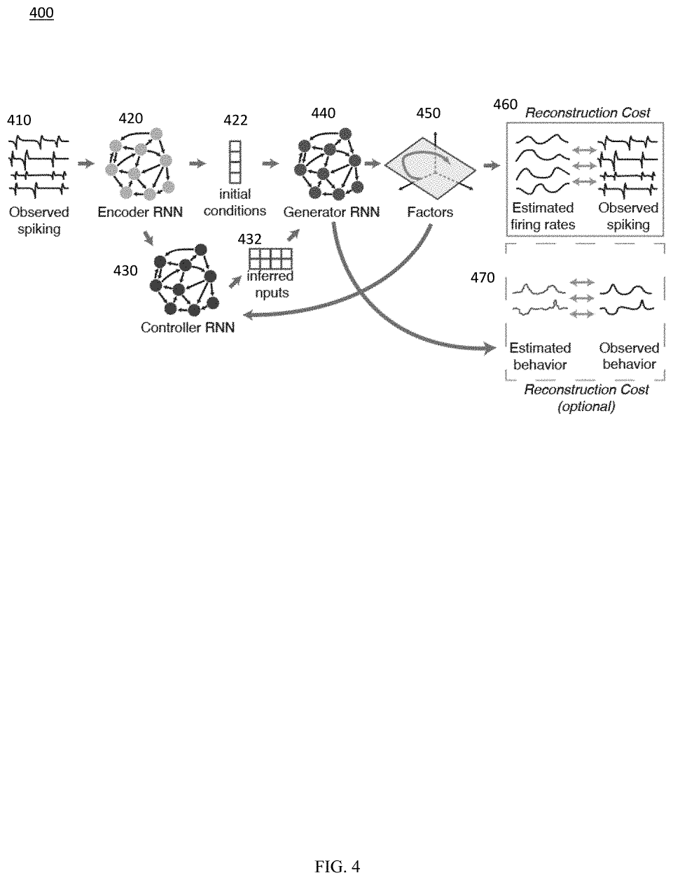

In some embodiments, at block 240, the system 110 may process the aligned variables through the trained latent model to determine a latent spatiotemporal representation (also referred to as “latent representation”) (e.g., manifold) of one or more brain state variables for the period of time. For example, the latent representation may be a vector of the values corresponding to one or more brain state variables in a latent data space for a time point. In some examples, the latent representations may lie along a manifold. FIGS. 3 and 4 discuss examples of the architectures of the trained latent model according to embodiments. In some examples, the one or more brain state variables may include but is not limited to generator state, firing/spiking rate, factor states (450), inferred inputs (432) (e.g., interbrain regional signaling, new information based on timing (e.g., a new generator state, firing/spike rate and/or factor state associated with an intention to move to the target device to a new location), etc.), initial conditions (422), among others, or any combination thereof.

By using the trained alignment network with the trained latent model, the distributions of the one or more brain state variables of the determined latent representation should be aligned with the distributions of the one or more brain state variables of the reference latent representation in the latent (spatiotemporal) space.

In some embodiments, at block 250, the system 110 may decode the latent representation for the time period into a brain state. The brain state may refer to mental intent or state (e.g., action conceived by the user to whom the system is applied), neurologic state, among others, or any combination thereof.

In some embodiments, at block 260, the system 110 may cause initiation of a command by the target device 130 corresponding to the state determined in block 250. For example, the system 110 may cause movement of a robotic or prosthetic limb, a peripheral device (e.g., a computer mouse, vehicle, etc.), stimulation of the brain of the user, action by a communication device, among others, or any combination thereof.

In some embodiments, at block 270, the system 110 may optionally update the trained latent model and/or the trained alignment network, for example, as discussed in FIGS. 3-5.

FIG. 3 shows an example of the architecture for training the networks and models according to embodiments. In some examples, the latent model 314 may be first trained in block 210 on an initial neural data training dataset 312 (e.g., data from day 0) to generate a reference latent representation 316. In some examples, a reconstruction cost 318 may be added to the model. FIG. 4 shows an example of a method of training the latent model according to embodiments.

Next, the alignment network 324 may be trained using neural data 322 from one or more future dates (e.g., data from data k). During the training of the alignment network 324, the trained latent model's 314 weights may be fixed, and only alignment weights can be learned. The core operating principle of the alignment process can be that the Generator RNN of the trained latent model approximates the spatiotemporal dynamics of the brain region and those determined dynamics can be generally consistent over time. The Generator RNN can produce the distributions of the certain brain state variables (e.g., factors and generator states). The changes in these distributions and the distributions of the other brain state variables can be corrected by the alignment network 324, whose objective is to minimize differences in the distributions of latent representations between the reference latent representation 316 and new latent representation 328 that is subject to nonstationarities. In this example, the training objective of the alignment network 324 may be set to minimize alignment costs, for example, the KL divergence, between the distributions of the latent representations between day 0 and future day (e.g., day k). For example, the neural data 322 may be processed through the trained latent model (i.e., fixing the latent model's weights) (e.g., trained at 310) to determine a latent representation 328. The alignment network 322 may be trained based on the alignment cost 330 between the reference latent representation 316 and the latent representation 328, for example, determined using KL divergence. FIG. 5 shows an example of a method of training an alignment network according to embodiments.

In some examples, the alignment cost may be implemented using a Wasserstein distance or Earth-Mover's distance instead of KL divergence. In some examples, this may be achieved through a generative adversarial network (GAN). In some examples, this GAN may be a Cycle-GAN

As nonstationarities affect the observed neural data, stability can be maintained by applying the alignment approach to new data in an unsupervised fashion. The resulting system can output latent representations (manifold trajectories) for a given brain state (e.g., behavior) that are generally consistent over long time periods, despite changes in the observed spiking inputs. These consistent trajectories can then be decoded by the trained, single fixed decoder.

FIG. 4 shows an example of an architecture 400 for training a latent model according to embodiments. In some embodiments, the architecture of the latent model and/or training of the latent model may be based on or incorporate the training/architecture discussed in Mohammad Reza Keshtkaran and Chethan Pandarinath, Enabling hyperparameter optimization in sequential autoencoders for spiking neural data, Advances in Neural Information Processing Systems 32 (NeurIPS 2019), https://proceedings.neurips.cc/paper/2019/file/6948bd44c9lacd2b54ecdd1b132f10fb-Paper.pdf; Pandarinath, C., O'Shea, D. J., Collins, J. et al. Inferring single-trial neural population dynamics using sequential auto-encoders, Nat Methods 15, 805-815 (2018). https://doi.org/10.1038/s41592-018-0109-9; and A large-scale neural network training framework for generalized estimation of single-trial population dynamics. Mohammad Reza Keshtkaran, Andrew R. Sedler, Raeed H. Chowdhury, Raghav Tandon, Diya Basrai, Sarah L. Nguyen, Hansem Sohn, Mehrdad Jazayeri, Lee E. Miller, Chethan Pandarinath. bioRxiv 2021.01.13.426570; doi: https://doi.org/10.1101/2021.01.13.426570; the disclosures of each of reference are hereby incorporated by reference in their entirety. In some embodiments, a different and/or additional training method and/or architecture of a latent model may be used.

Operations in architecture 400 may begin when the system 110 may receive neural data 410 associated with a user for a period of time from the one or more sensors 120. For example, the neural data may be received from a microelectrode array disposed in the motor cortex of the user for a period of time (e.g., long stretch of time (e.g., on the order of hours, minutes (e.g., 10 minutes), etc.). Next, the data 110 may be separated into time intervals (e.g., shorter time periods (e.g., on the order of minutes, seconds (e.g. 1 second), etc.)) containing time points (e.g., on the order of milliseconds (e.g., 10 ms)).

Next, at components 420-470, all of the time intervals may be processed either serially/parallel or each subset may be processed sequentially. At block 420, a first subset of data may be passed into the Encoder RNN 420, which produces a set of initial conditions 422 for that subset. At 430, the initial conditions 422 can be passed into the Generator RNN 440, which produces a latent representation known as the factors 450. In some examples, the factors 450 may be used to reconstruct at 460 one or more other brain state variables, such as estimated firing rates, that describe the original subset of neural activity.

Next, at 460, the estimated firing rates can be compared to the original input neural data 410 using a reconstruction cost. The latent model can be trained with the objective of minimizing the reconstruction cost.

In some examples, in order to improve the accuracy of this modelling, the initial conditions from the Encoder RNN 420, as well as the factors 450, can be processed by a Controller RNN 430 to determine whether the modelling of the factors 450 could be improved by adding an inferred input(s) 432 to the Generator RNN 440.

The training of the latent model, 420-460, may be repeated until the difference between the estimated firing rates and inputted neural data determined at 460 meets stopping criteria (e.g., the difference has stopped decreasing for a set number of iterations). That way, the difference between the estimated firing rates and the inputted neural data can be minimized.

In some embodiments, the latent model may optionally also be trained to predict the behavior that the subject was performing while the neural data was recorded, for example, at 470. For example, a latent representation within the latent model such as the generator states (taken from the Generator RNN 440), the factors 450, the inferred inputs 432, the initial conditions 422, can be used to predict an estimate of the brain state, such as the intended behavior. At 470, the estimated brain state/behavior may be compared to the observed brain state/behavior. These steps may be repeated until the difference between the estimated brain state/behavior and the observed brain state/behavior meets stopping criteria (e.g., the difference has stopped decreasing for a set number of iterations). By way of example, the model may be trained accordingly to this option to improve accuracy of the predicted brain state or behavior during potential brain computer interface (BCI) use.

FIG. 5 shows flow chart 500 illustrating examples of training an alignment network using a trained latent model, for example, as shown in FIG. 4, according to embodiments. Operations in flow chart 500 may begin at block 510, the system 110 may receive a training set of neural data associated with a user for one or more periods of time from the one or more sensors 120. For example, the neural data may be received from a microelectrode array disposed in the motor cortex of the user. The training set of neural data for the alignment network will be different from the training set for the latent model (FIG. 4). For example, the training set for the alignment network will be for a future day K after the training set for the latent model (for day 0).

In some embodiments, the device 110, at block 520, may determine one or more subsets from the training set from the period of time. Each subset may be for a different period of time. The one or more subsets may be considered an epoch for processing. In some examples, the system may process the subsets of the epoch individually through blocks/steps 530-570 or serially/in parallel through blocks/steps 530-570.

In some embodiments, the device 110, at block 530, may optionally convert each subset of the neural data to standardized dimension(s). For example, the neural data may be transformed to reduce dimensions, for example, using a linear dimensionality reduction technique, to a standardized temporal dimension. For example, this can address if one or more of the electrodes of the microelectrode array malfunctions.

Next, at block 540, each subset/one subset may be processed through the alignment network to transform the (standardized) neural data into aligned variables. For example, the system 110 may apply the initial/current alignment weights to the neural data, for example, learned with KL divergence, so when the aligned variables are processed by the trained latent representation model (at 550), the determined latent representations better align to the distributions of brain state variables (e.g., latent space) of the reference latent representation.

In some embodiments, at block 550, the system 110 may determine a latent representation (e.g., manifold) of one or more brain state variables for that subset/each subset of the epoch using the aligned variables and the trained latent model (FIGS. 3 and 4). The one or more brain state variables may include but is not limited to generator state, firing/spiking rate, factor state, inferred inputs, initial conditions, among others, or any combination thereof.

In some embodiments, at block 560, the system 110 may compare the latent representation determined in block 550 to the reference latent representation (316) to determine whether the differences meet the stopping criteria. For example, the stopping criteria may be a threshold, number of iterations/epochs, among others, or a combination thereof. By way of example, the differences may be determined by calculating an alignment metric, such as the KL divergence (e.g., KL cost) between the two representations. For example, the KL divergence may be determined using the mean and covariance matrices of the two representations.

If the differences meet the stopping criteria at block 560, the training may stop and the trained alignment network having the weights used in block 540 may be stored (for future use). If the differences do not meet the stopping criteria at block 560, the alignment weights of the alignment network may be updated to minimize the differences in distributions between the representations at block 570.

If the subsets of the epoch were processed individually in blocks 530-570, the system 110 may determine at block 580, whether there are any remaining subsets in the epoch. If the system 110 determines that there are remaining subsets of the epoch (YES at 580), the system 110 may process another subset through the alignment network (block 590) to determine aligned variables (block 540) and process the aligned variables through blocks 550-580 until no remaining subsets of the epoch (NO at 580). If the system determines that there are no remaining subsets of the epoch (NO at 580), the system 110 may determine a different set of subsets for an epoch at block 520 and repeat blocks 530-580.

Alternatively, if the subsets of the epoch were processed serially/in parallel in blocks 530-570, the system 110 may determine a different set of one or more subsets from the training set for another epoch at block 520 and repeat blocks/steps 520-570 until that epoch meets the stopping criteria.

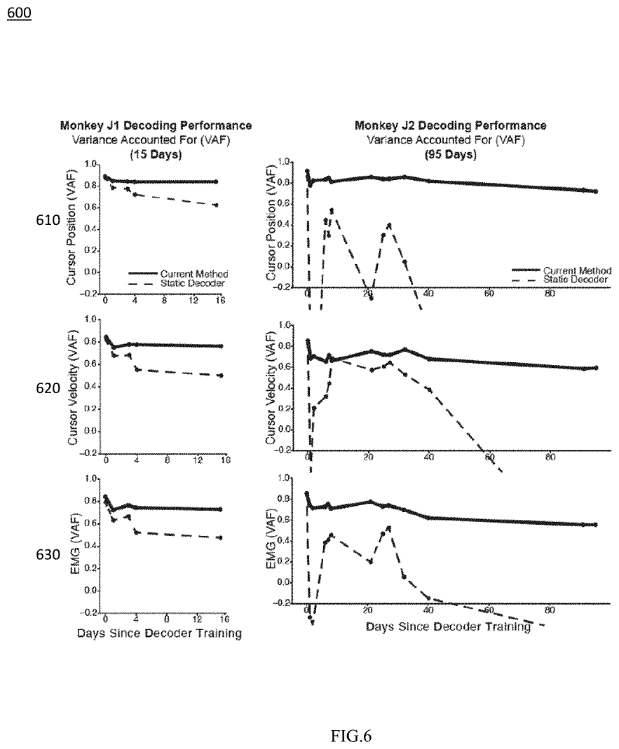

FIG. 6 shows an example of results 610, 620, 630 demonstrating the advantage of using the disclosed method to align latent representations across days prior to decoding a behavioral parameter. Each column shows results for a different dataset, where the left dataset spans a total of 15 days and the right spans a total of 95 days. Each row shows the results of predicting a different behavioral variable: the position of a cursor on a screen while a monkey is moving it (top) 610, the velocity of that cursor (middle) 620, and electromyographic signals which measure muscle activity (bottom) 630. The solid black lines show the accuracy of prediction on each day if the disclosed method is applied to align latent representations before applying a neural decoder that was trained on Day 0 only. The dashed lines show the accuracy of prediction on each day if the neural data is smoothed by convolving with a 60 ms Gaussian kernel and then a neural decoder that was trained on Day 0 only is applied. As shown, the performance using the disclosed method results in higher accuracy and more stable predictions over the full timespan.

FIG. 7 depicts a block diagram of an example computing system 700 for implementing certain embodiments. For example, in some aspects, the computer system 700 may include computing systems associated with a device (e.g., the device 110) performing one or more processes (e.g., FIGS. 2-5) disclosed herein. The block diagram illustrates some electronic components or subsystems of the computing system. The computing system 700 depicted in FIG. 7 is merely an example and is not intended to unduly limit the scope of inventive embodiments recited in the claims. One of ordinary skill in the art would recognize many possible variations, alternatives, and modifications. For example, in some implementations, the computing system 700 may have more or fewer subsystems than those shown in FIG. 7, may combine two or more subsystems, or may have a different configuration or arrangement of sub systems.

In the example shown in FIG. 7, the computing system 700 may include one or more processing units 710 and storage 720. The processing units 710 may be configured to execute instructions for performing various operations, and can include, for example, a micro-controller, a general-purpose processor, or a microprocessor suitable for implementation within a portable electronic device, such as a Raspberry Pi. The processing units 710 may be communicatively coupled with a plurality of components within the computing system 700. For example, the processing units 710 may communicate with other components across a bus. The bus may be any subsystem adapted to transfer data within the computing system 700. The bus may include a plurality of computer buses and additional circuitry to transfer data.

In some embodiments, the processing units 710 may be coupled to the storage 720. In some embodiments, the storage 720 may offer both short-term and long-term storage and may be divided into several units. The storage 720 may be volatile, such as static random access memory (SRAM) and/or dynamic random access memory (DRAM), and/or non-volatile, such as read-only memory (ROM), flash memory, and the like. Furthermore, the storage 720 may include removable storage devices, such as secure digital (SD) cards. The storage 720 may provide storage of computer readable instructions, data structures, program modules, audio recordings, image files, video recordings, and other data for the computing system 700. In some embodiments, the storage 720 may be distributed into different hardware modules. A set of instructions and/or code might be stored on the storage 720. The instructions might take the form of executable code that may be executable by the computing system 700, and/or might take the form of source and/or installable code, which, upon compilation and/or installation on the computing system 700 (e.g., using any of a variety of generally available compilers, installation programs, compression/decompression utilities, and the like), may take the form of executable code.

In some embodiments, the storage 720 may store a plurality of application modules 724, which may include any number of applications, such as applications for controlling input/output (I/O) devices 740 (e.g., sensor(s) (e.g., sensor(s) 770, other sensor(s), etc.)), a switch, a camera, a microphone or audio recorder, a speaker, a media player, a display device, etc.). The application modules 724 may include particular instructions to be executed by the processing units 710. In some embodiments, certain applications or parts of the application modules 724 may be executable by other hardware modules, such as a communication subsystem 750. In certain embodiments, the storage 720 may additionally include secure memory, which may include additional security controls to prevent copying or other unauthorized access to secure information.

In some embodiments, the storage 720 may include an operating system 722 loaded therein, such as an Android operating system or any other operating system suitable for mobile devices or portable devices. The operating system 722 may be operable to initiate the execution of the instructions provided by the application modules 724 and/or manage other hardware modules as well as interfaces with a communication subsystem 750 which may include one or more wireless or wired transceivers. The operating system 722 may be adapted to perform other operations across the components of the computing system 700 including threading, resource management, data storage control, and other similar functionality.

The communication subsystem 750 may include, for example, an infrared communication device, a wireless communication device and/or chipset (such as a Bluetooth® device, an IEEE 802.11 (Wi-Fi) device, a WiMax device, cellular communication facilities, and the like), NFC, ZigBee, and/or similar communication interfaces. The computing system 700 may include one or more antennas (not shown in FIG. 7) for wireless communication as part of the communication subsystem 750 or as a separate component coupled to any portion of the system.

Depending on desired functionality, the communication subsystem 750 may include separate transceivers to communicate with base transceiver stations and other wireless devices and access points, which may include communicating with different data networks and/or network types, such as wireless wide-area networks (WWANs), WLANs, or wireless personal area networks (WPANs). A WWAN may be, for example, a WiMax (IEEE 802.9) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. In some embodiments, the communications subsystem 750 may include wired communication devices, such as Universal Serial Bus (USB) devices, Universal Asynchronous Receiver/Transmitter (UART) devices, Ethernet devices, and the like. The communications subsystem 750 may permit data to be exchanged with a network, other computing systems, and/or any other devices described herein. The communication subsystem 750 may include a means for transmitting or receiving data, such as identifiers of portable goal tracking devices, position data, a geographic map, a heat map, photos, or videos, using antennas and wireless links. The communication subsystem 750, the processing units 710, and the storage 720 may together comprise at least a part of one or more of a means for performing some functions disclosed herein.

The computing system 700 may include one or more I/O devices 740, such as sensors 770, a switch, a camera, a microphone or audio recorder, a communication port, or the like. For example, the I/O devices 740 may include one or more touch sensors or button sensors associated with the buttons. The touch sensors or button sensors may include, for example, a mechanical switch or a capacitive sensor that can sense the touching or pressing of a button.

In some embodiments, the I/O devices 740 may include a microphone or audio recorder that may be used to record an audio message. The microphone and audio recorder may include, for example, a condenser or capacitive microphone using silicon diaphragms, a piezoelectric acoustic sensor, or an electret microphone. In some embodiments, the microphone and audio recorder may be a voice-activated device. In some embodiments, the microphone and audio recorder may record an audio clip in a digital format, such as MP3, WAV, WMA, DSS, etc. The recorded audio files may be saved to the storage 720 or may be sent to the one or more network servers through the communication subsystem 750.

In some embodiments, the I/O devices 740 may include a location tracking device, such as a global positioning system (GPS) receiver. In some embodiments, the I/O devices 740 may include a wired communication port, such as a micro-USB, Lightning, or Thunderbolt transceiver.

The I/O devices 740 may also include, for example, a speaker, a media player, a display device, a communication port, or the like. For example, the I/O devices 740 may include a display device, such as an LED or LCD display and the corresponding driver circuit. The I/O devices 740 may include a text, audio, or video player that may display a text message, play an audio clip, or display a video clip.

The computing system 700 may include a power device 760, such as a rechargeable battery for providing electrical power to other circuits on the computing system 700. The rechargeable battery may include, for example, one or more alkaline batteries, lead-acid batteries, lithium-ion batteries, zinc-carbon batteries, and NiCd or NiMH batteries. The computing system 700 may also include a battery charger for charging the rechargeable battery. In some embodiments, the battery charger may include a wireless charging antenna that may support, for example, one of Qi, Power Matters Association (PMA), or Association for Wireless Power (A4WP) standard, and may operate at different frequencies. In some embodiments, the battery charger may include a hard-wired connector, such as, for example, a micro-USB or Lightning® connector, for charging the rechargeable battery using a hard-wired connection. The power device 760 may also include some power management integrated circuits, power regulators, power convertors, and the like.

In some embodiments, the computing system 700 may include one or more sensors 770. The sensors 770 may include, for example, the sensors as described above.

The computing system 700 may be implemented in many different ways. In some embodiments, the different components of the computing system 700 described above may be integrated to a same printed circuit board. In some embodiments, the different components of the computing system 700 described above may be placed in different physical locations and interconnected by, for example, electrical wires. The computing system 700 may be implemented in various physical forms and may have various external appearances. The components of computing system 700 may be positioned based on the specific physical form.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a subscription and data receiving associated with a different subscription, such identifiers are merely for convenience and are not meant to limit various embodiments to a particular order, sequence, type of network or carrier.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing systems, (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more example embodiments, the functions described may be implemented in hardware, software, firmware, or any combination thereof. If implemented in software, the functions may be stored as one or more instructions or code on a non-transitory computer readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, and the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The disclosures of each and every publication cited herein are hereby incorporated herein by reference in their entirety.

While the disclosure has been described in detail with reference to exemplary embodiments, those skilled in the art will appreciate that various modifications and substitutions may be made thereto without departing from the spirit and scope of the disclosure as set forth in the appended claims. For example, elements and/or features of different exemplary embodiments may be combined with each other and/or substituted for each other within the scope of this disclosure and appended claims.

What is claimed:

1. A method for controlling a target device using a brain computer interface (BCI), comprising:
receiving neural data for a period of time from one or more sensors;
transforming the neural data to generate aligned variables using a trained alignment network;
processing the aligned variables through a trained latent model to determine a latent spatiotemporal representation of one or more brain state variables for the period of time; and
decoding the latent spatiotemporal representation into a brain state for the period of time.

2. The method according to claim 1, further comprising:
causing an initiation of a command corresponding to the brain state to control a target device.

3. The method according to claim 1, wherein the one or more brain state variables includes generator state, firing/spiking rate, inferred inputs, initial conditions, and/or factor state.

4. The method according to claim 1, wherein the trained alignment network is trained using the trained latent model.

5. The method according to claim 4, wherein the trained alignment network and the trained latent model are trained using different training datasets of neural data collected at different periods of time.

6. The method according to claim 1, wherein the transforming uses weights of the trained alignment network and alignment network architecture to generate the aligned variables.

7. The method according to claim 1, further comprising:
transforming the neural data to standardized data having standardized dimensions,
wherein the standardized data is transformed into the aligned variables.

8. A system, comprising:
one or more processors; and
one or more hardware storage devices having stored thereon computer-executable instructions which are executable by the one or more processors to cause the computing system to perform at least the following:
receiving neural data for a period of time from one or more sensors;
transforming the neural data to generate aligned variables using a trained alignment network;
processing the aligned variables through a trained latent model to determine a latent spatiotemporal representation of one or more brain state variables for the period of time; and
decoding the latent spatiotemporal representation into a brain state for the period of time.

9. The system according to claim 8, wherein the one or more processors are further configured to cause the computing system to perform at least the following:
causing an initiation of a command corresponding to the brain state to control a target device.

10. The system according to claim 8, wherein the one or more brain state variables includes generator state, firing/spiking rate, inferred inputs, initial conditions, and/or factor state.

11. The system according to claim 8, wherein the trained alignment network is trained using the trained latent model.

12. The system according to claim 11, wherein the trained alignment network and the trained latent model are trained using different training datasets of neural data collected at different periods of time.

13. The system according to claim 8, wherein the transforming uses weights of the trained alignment network and alignment network architecture to generate the aligned variables.

14. The system according to claim 8, wherein the one or more processors are further configured to cause the computing system to perform at least the following:
transforming the neural data to standardized data having standardized dimensions,
wherein the standardized data is transformed into the aligned variables.
